(19) United States
(12) Patent Application Publication
(10) Pub. No.: US 2024/0097281 A1
(43) Pub. Date: Mar. 21, 2024

(54) BUS BAR AND BATTERY MODULE INCLUDING THE SAME

(71) Applicant: SK ON CO., LTD., Seoul (KR)

(72) Inventors: Hoemin CHEONG, Daejeon (KR); Seul Gi LEE, Daejeon (KR)

(21) Appl. No.: 18/307,814

(22) Filed: Apr. 27, 2023

(30) Foreign Application Priority Data
May 4, 2022 (KR) 10-2022-0055492

(51) Int. Cl. H01M 50/505; H01M 50/536

(52) U.S. Cl. CPC H01M 50/505; H01M 50/536

(57) ABSTRACT

A bus bar and a battery module including the same are disclosed. The bus bar comprises a bus bar plate having a front surface and a rear surface; a plurality of bus bar coupling parts formed on the bus bar plate, each of the plurality of bus bar coupling parts extending in a longitudinal direction, the plurality of bus bar coupling parts being spaced apart in a transverse direction; a bus bar connection part formed on the bus bar plate and positioned between the plurality of bus bar coupling parts; and an at least one rib positioned on the bus bar connection part, the at least one rib protruding from at least one of the front surface and the rear surface of the bus bar plate.

### CROSS-REFERENCE TO RELATED APPLICATIONS

This application claims the priority benefit of Korean Patent Application No. 10-2022-0055492 filed on May 4, 2022, which is incorporated herein by reference for all purposes as if fully set forth herein.

### TECHNICAL FIELD

The present disclosure relates to a bus bar and a battery module including the same. More particularly, the present disclosure relates to a bus bar preventing the bending and a battery module including the same.

### BACKGROUND

In a battery module, a bus bar may be coupled and fixed to a plurality of electrode leads by welding to electrically connect the plurality of electrode leads. In a process of welding the bus bar and the electrode leads, heat is provided to the bus bar, and the heat provided to the bus bar may deform a shape of the bus bar.

Accordingly, it may be necessary to provide rigidity to the bus bar so that the shape of the bus bar is not deformed even if heat is provided to the bus bar.
(Patent Document 1) KR 10-2244120 B1

### SUMMARY

An object of the present disclosure is to address the above-described and other problems.

Another object of the present disclosure is to provide a bus bar preventing the bending even if there is a welding process, and a battery module including the bus bar.

Another object of the present disclosure is to provide a bus bar provided with a rib of a shape protruding from a bus bar plate, and a battery module including the bus bar.

Another object of the present disclosure is to provide a bus bar including a rib formed by press-processing the bus bar, and a battery module including the bus bar.

In order to achieve the above-described and other objects and needs, in one aspect of the present disclosure, there is provided a bus bar comprising a bus bar plate having a front surface and a rear surface; a plurality of bus bar coupling parts formed on the bus bar plate, each of the plurality of bus bar coupling parts extending in a longitudinal direction, the plurality of bus bar coupling parts being spaced apart in a transverse direction; a bus bar connection part formed on the bus bar plate and positioned between the plurality of bus bar coupling parts; and an at least one rib positioned on the bus bar connection part, the at least one rib protruding from at least one of the front surface and the rear surface of the bus bar plate.

In another aspect of the present disclosure, there is provided a battery module comprising a plurality of battery cells each including a battery cell body and an electrode lead protruding forward from the battery cell body, the plurality of battery cells being disposed in a transverse direction; and a bus bar coupled to the electrode leads at a front of the battery cell body, wherein the bus bar includes a bus bar plate having a front surface facing the front and a rear surface facing the battery cell body; a plurality of bus bar coupling parts respectively coupled to the electrode leads of the plurality of battery cells and disposed in the transverse direction; a bus bar connection part formed on the bus bar plate and positioned between the plurality of bus bar coupling parts; and an at least one rib positioned on the bus bar connection part, the at least one rib protruding from at least one of the front surface and the rear surface of the bus bar plate.

Effects of a bus bar and a battery cell including the same according to the present disclosure are described as follows.

According to at least one aspect of the present disclosure, the present disclosure can provide a bus bar preventing the bending even if there is a welding process, and a battery module including the bus bar.

According to at least one aspect of the present disclosure, the present disclosure can provide a bus bar provided with a rib of a shape protruding from a bus bar plate, and a battery module including the bus bar.

According to at least one aspect of the present disclosure, the present disclosure can provide a bus bar including a rib formed by press-processing the bus bar, and a battery module including the bus bar.

Additional scope of applicability of the present disclosure will become apparent from the detailed description given blow. However, it should be understood that the detailed description and specific examples such as embodiments of the present disclosure are given merely by way of example, since various changes and modifications within the spirit and scope of the present disclosure will become apparent to those skilled in the art from the detailed description.

### BRIEF DESCRIPTION OF THE DRAWINGS

The accompanying drawings, which are included to provide a further understanding of the disclosure and are incorporated in and constitute a part of the disclosure, illustrate embodiments of the disclosure and together with the description serve to explain the principle of the disclosure.

FIG. 1 illustrates a battery cell assembly according to an embodiment of the present disclosure.

FIG. 2 illustrates a battery module according to an embodiment of the present disclosure.

FIGS. 3 and 4 illustrate a bus bar according to an embodiment of the present disclosure.

FIG. 5 illustrates a cross section of a bus bar of FIG. 3 taken along B-B.

FIG. 6 illustrates a cross section of a battery module of FIG. 2 taken along A-A.

FIG. 7 illustrates that one electrode lead is divided into a plurality of sections and is welded to a bus bar coupling part.

FIG. 8 illustrates that one electrode lead consists of one section and is welded to a bus bar coupling part.

FIG. 9 illustrates a bus bar including a rib according to an embodiment of the present disclosure.

FIGS. 10 to 14 illustrate a rib of various shapes when viewed from the front of the rib.

FIG. 15 illustrates a cross section of a bus bar of FIG. 9 taken along C-C.

FIG. 16 is a cross-sectional view of a bus bar and illustrates that a plurality of ribs are disposed in a longitudinal direction of a bus bar slit.

FIG. 17 is a cross-sectional view of a bus bar and illustrates that one concave rib is formed between two convex ribs.

FIG. 18 is a cross-sectional view of a bus bar and illustrates that one convex rib is formed between two concave ribs.

FIG. 19 illustrates a bus bar having a reinforcement hole formed in a bus bar connection part in accordance with an embodiment of the present disclosure.

FIG. 20 is a partial enlarged view of a bus bar illustrated in FIG. 19.

FIG. 21 illustrates a cross section of a bus bar of FIG. 19 taken along D1-D2.

FIG. 22 is a cross-sectional view of a battery module of FIG. 2 taken along A-A and illustrates that an electrode lead passes through a bus bar and protrudes from the bus bar.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts. In general, a suffix such as “module” and “unit” may be used to refer to elements or components. Use of such a suffix herein is merely intended to facilitate description of the present disclosure, and the suffix itself is not intended to give any special meaning or function. It will be noted that a detailed description of known arts will be omitted if it is determined that the detailed description of the known arts can obscure the embodiments of the disclosure. The accompanying drawings are used to help easily understand various technical features and it should be understood that embodiments presented herein are not limited by the accompanying drawings. As such, the present disclosure should be construed to extend to any alterations, equivalents and substitutes in addition to those which are particularly set out in the accompanying drawings.

The terms including an ordinal number such as first, second, etc. may be used to describe various components, but the components are not limited by such terms. The terms are used only for the purpose of distinguishing one component from other components.

When any component is described as “being connected” or “being coupled” to other component, this should be understood to mean that another component may exist between them, although any component may be directly connected or coupled to the other component. In contrast, when any component is described as “being directly connected” or “being directly coupled” to other component, this should be understood to mean that no component exists between them.

A singular expression can include a plural expression as long as it does not have an apparently different meaning in context.

In the present disclosure, terms “include” and “have” should be understood to be intended to designate that illustrated features, numbers, steps, operations, components, parts or combinations thereof are present and not to preclude the existence of one or more different features, numbers, steps, operations, components, parts or combinations thereof, or the possibility of the addition thereof.

In the drawings, sizes of the components may be exaggerated or reduced for convenience of explanation. For example, the size and the thickness of each component illustrated in the drawings are arbitrarily illustrated for convenience of explanation, and thus the present disclosure is not limited thereto unless specified as such.

If any embodiment is implementable differently, a specific order of processes may be performed differently from the order described. For example, two consecutively described processes may be performed substantially at the same time, or performed in the order opposite to the described order.

In the following embodiments, when layers, areas, components, etc. are connected, the following embodiments include both the case where layers, areas, and components are directly connected, and the case where layers, areas, and components are indirectly connected to other layers, areas, and components intervening between them. For example, when layers, areas, components, etc. are electrically connected, the present disclosure includes both the case where layers, areas, and components are directly electrically connected, and the case where layers, areas, and components are indirectly electrically connected to other layers, areas, and components intervening between them.

In the drawings of the present disclosure, an XYZ coordinate system may be displayed. The XYZ coordinate system may be cartesian coordinate system. In the XYZ coordinate system, an X-axis direction may be referred to as an “X direction” and may be parallel to a direction in which a plurality of battery cells 110 are stacked. In the XYZ coordinate system, a Y-axis direction may be referred to as a “Y direction” and may be parallel to a longitudinal direction of the battery cell 110. In the XYZ coordinate system, a Z-axis direction may be referred to as a “Z direction” or a “vertical direction”. A plane formed by the X-axis and the Y-axis may be parallel to a horizontal plane.

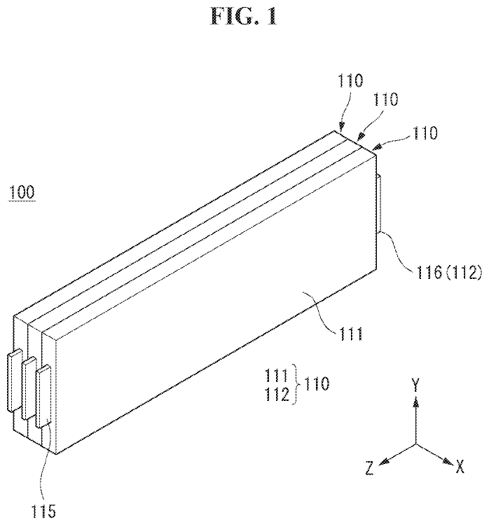

FIG. 1 illustrates a battery cell assembly according to an embodiment of the present disclosure.

Referring to FIG. 1, a battery cell assembly 100 may include a plurality of battery cells 110. The plurality of battery cells 110 may be stacked in one direction. For example, the plurality of battery cells 110 may be stacked in the X direction.

The battery cell 110 may include a battery cell body 111. The battery cell body 111 may be, for example, a pouch type. The battery cell body 111 may include an electrode assembly and an exterior material (pouch) surrounding the electrode assembly. The electrode assembly may be referred to as a “jelly roll”.

The battery cell body 111 may form a plate shape. For example, the battery cell body 111 may form a shape extending on a plane perpendicular to a direction in which the battery cells 110 are stacked.

The battery cell body 111 may extend from one end and lead to other end. For example, the battery cell body 111 may extend rearward from a front end and lead to a rear end. An extended direction of the battery cell body 111 may be parallel to a longitudinal direction of the battery cell body 111.

The battery cell 110 may include an electrode lead 112. The electrode lead 112 may be formed to extend or protrude from the battery cell body 111. The electrode lead 112 may be connected to the battery cell body 111. Electric power from the battery cell body 111 may be provided to the outside through the electrode lead 112. Alternatively, external power may be provided to the battery cell body 111 through the electrode lead 112.

The electrode lead 112 may be formed at a perimeter of the battery cell body 111. For example, the electrode lead 112 may be positioned at an end of the battery cell body 111. A plurality of electrode leads 112 may be provided. For example, the electrode leads 112 may include a first electrode lead 115 and a second electrode lead 116.

The first electrode lead 115 may be positioned at the front end of the battery cell body 111. The second electrode lead 116 may be positioned at the rear end of the battery cell body 111. An electrode polarity of the first electrode lead 115 may be different from an electrode polarity of the second electrode lead 116. For example, if the first electrode lead 115 is an anode, the second electrode lead 116 may be a cathode.

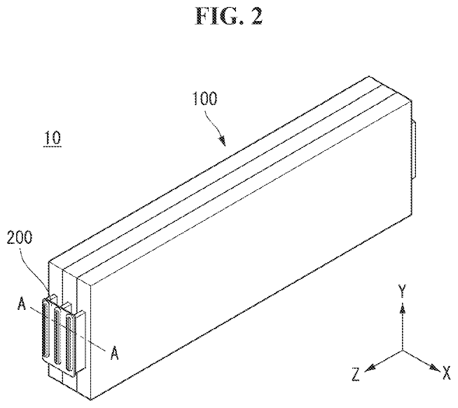

FIG. 2 illustrates a battery module according to an embodiment of the present disclosure. In FIG. 2, illustration of a case of a battery module 10 may be omitted for convenience of description.

Referring to FIGS. 1 and 2, the battery module 10 may include the battery cell assembly 100 and a bus bar 200. The bus bar 200 may be coupled to the electrode lead 112 of the battery cell 110. For example, the bus bar 200 may be coupled to the first electrode lead 115.

The bus bar 200 may connect the plurality of battery cells 110. For example, the bus bar 200 may electrically connect the plurality of battery cells 110. For example, the bus bar 200 may be coupled to one end of the battery cell assembly 100. For example, the bus bar 200 may connect the first electrode leads 115 of the plurality of battery cells 110 to each other.

In FIG. 2, one bus bar 200 may be illustrated for convenience of description. For another example, a plurality of bus bars 200 may be provided. For example, a first bus bar 200 may be coupled to the front end of the battery cell assembly 100 to connect the first electrode leads 115 of the plurality of battery cells 110 to each other, and a second bus bar 200 may be coupled to the rear end of the battery cell assembly 100 to connect the second electrode leads 116 of the plurality of battery cells 110 to each other.

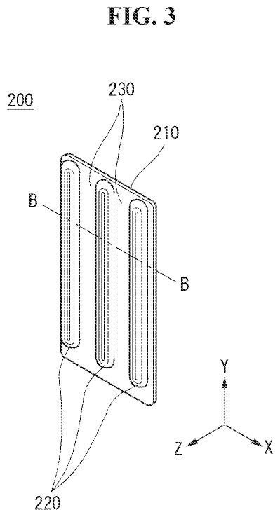

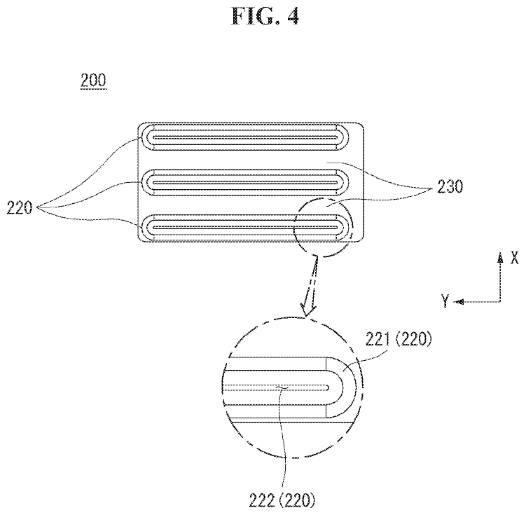

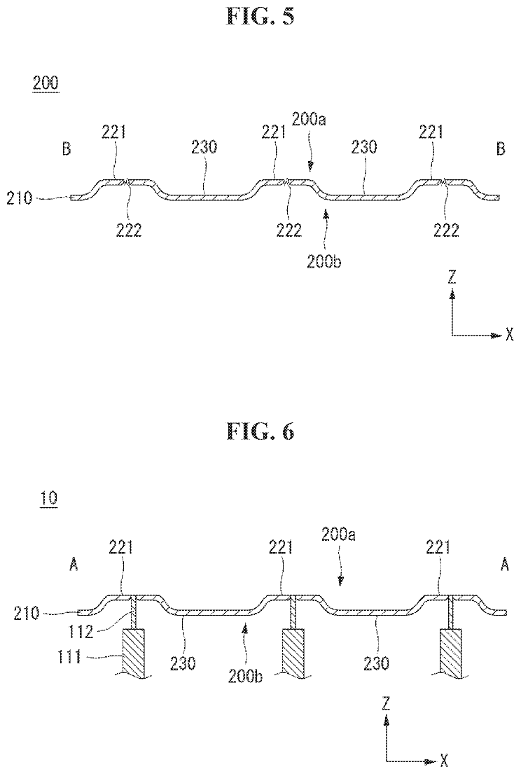

FIGS. 3 and 4 illustrate the bus bar 200 according to an embodiment of the present disclosure. More specifically, FIG. 3 is a perspective view of the bus bar 200, and FIG. 4 illustrates the bus bar 200 when viewed from the front. FIG. 5 illustrates a cross section of the bus bar 200 of FIG. 3 taken along B-B.

Referring to FIGS. 3 to 5, the bus bar 200 may include a bus bar plate 210. The bus bar plate 210 may form a skeleton of the bus bar 200. The bus bar plate 210 may be formed of a material containing metal. For example, the bus bar plate 210 may be formed of a metal plate.

The bus bar plate 210 may form a shape of a plate. For example, the bus bar plate 210 may form both surfaces. For example, one surface of the bus bar plate 210 may face the battery cell body 111 (see FIG. 1). For example, the other surface of the bus bar plate 210 may be the opposite surface of the one surface. That is, the other surface of the bus bar plate 210 may face the front.

The other surface of the bus bar plate 210 may be a front surface of the bus bar plate 210 and may be referred to as a “first bus bar surface 200a” as the other surface of the bus bar 200.

The one surface of the bus bar plate 210 may be a rear surface of the bus bar plate 210 and may be referred to as a “second bus bar surface 200b” as one surface of the bus bar 200.

The bus bar 200 may include a bus bar coupling part 220. The bus bar coupling part 220 may be formed on the bus bar plate 210. The bus bar coupling part 220 may be coupled to the electrode lead 112 (see FIG. 1).

A plurality of bus bar coupling parts 220 may be provided. The number of the plurality of bus bar coupling parts 220 may correspond to the number of the plurality of battery cells 110 (see FIG. 1). The plurality of bus bar coupling parts 220 may be spaced apart from each other in a direction in which the plurality of battery cells 110 (see FIG. 1) are stacked.

The bus bar coupling part 220 may include a bus bar coupling part body 221. The bus bar coupling part body 221 may be formed to elongate along between the two adjacent bus bar coupling part bodies 221. In other words, the bus bar coupling part body 221 may be formed in an extended shape along between the two adjacent bus bar coupling part bodies 221.

The bus bar coupling part 220 may include a bus bar slit 222. The bus bar slit 222 may be formed along a longitudinal direction of the bus bar coupling part body 221. The bus bar slit 222 may refer to a slit formed in the bus bar coupling part body 221.

The bus bar slit 222 may pass through the bus bar coupling part body 221 in a front-rear direction. That is, the bus bar slit 222 may be connected to a front surface and a rear surface of the bus bar coupling part body 221. In other words, the bus bar slit 222 may extend from the front surface of the bus bar coupling part body 221 and lead to the rear surface of the bus bar coupling part body 221. The bus bar slit 222 may provide a space in which the electrode lead 112 (see FIG. 1) is accommodated.

The bus bar 200 may include a bus bar connection part 230. The bus bar connection part 230 may be formed on the bus bar plate 210. The bus bar connection part 230 may refer to a part between the two adjacent bus bar coupling parts 220 in the bus bar plate 210. A plurality of bus bar connection parts 230 may be formed.

The bus bar connection part 230 may be positioned behind the bus bar coupling part 220. In other words, the bus bar coupling part 220 may protrude forward from the bus bar connection part 230.

FIG. 6 illustrates a cross section of the battery module 10 of FIG. 2 taken along A-A.

Referring to FIG. 6, the plurality of electrode leads 112 may be respectively inserted into the plurality of bus bar slits 222 (see FIG. 5). Hence, the plurality of electrode leads 112 may be electrically connected to the bus bar plate 210. In order to increase a coupling strength between the plurality of electrode leads 112 and the bus bar 200 (see FIG. 5), the plurality of electrode leads 112 and the bus bar coupling parts 220 may be coupled by welding.

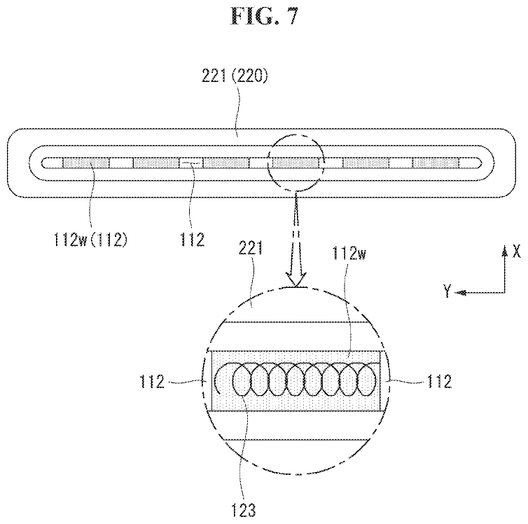

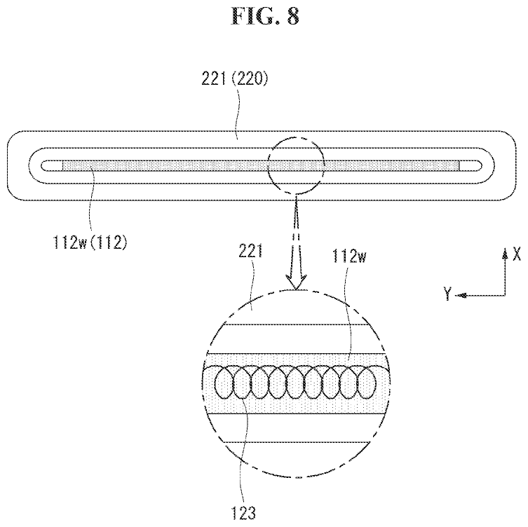

FIG. 7 illustrates that one electrode lead 112 is divided into a plurality of sections and is welded to the bus bar coupling part 220. FIG. 8 illustrates that one electrode lead 112 consists of one section and is welded to the bus bar coupling part 220.

Referring to FIGS. 7 and 8, the electrode lead 112 and the bus bar coupling part 220 may be coupled to each other by welding. For example, the electrode lead 112 and the bus bar coupling part 220 may be coupled to each other by laser welding. A laser beam may be irradiated to the electrode lead 112 while forming a welding line 123 on the electrode lead 112.

The electrode lead 112 may be converted into an electrode lead welding part 112w by irradiation of a laser beam. In other words, the electrode lead welding part 112w may refer to a portion of the electrode lead 112 that is welded by irradiation of the laser beam.

The welding line 123 may have a shape in which a circular shape repeatedly moves in one direction. That is, the electrode lead 112 and the bus bar coupling part 220 may be coupled by wobble welding. As a result, the electrode lead 112 and the bus bar coupling part 220 can be precisely welded and coupled, and the stability of the manufacturing process of the battery module 10 (see FIG. 2) can be improved.

In one electrode lead 112, the electrode lead welding part 112w may be formed as one part or a plurality of parts. For example, as illustrated in FIG. 7, the electrode lead welding part 112w may be divided into a plurality of sections and formed as a plurality of parts. For example, as illustrated in FIG. 8, the electrode lead welding part 112w may be formed as one part.

In the process of coupling the electrode lead 112 and the bus bar coupling part 220 by welding, heat or/and pressure may be applied to the bus bar plate 210 (see FIG. 3). Due to this, there may be a possibility that the bus bar plate 210 (see FIG. 3) is twisted during the welding process. Therefore, it may be necessary to add rigidity to the bus bar plate 210 (see FIG. 3).

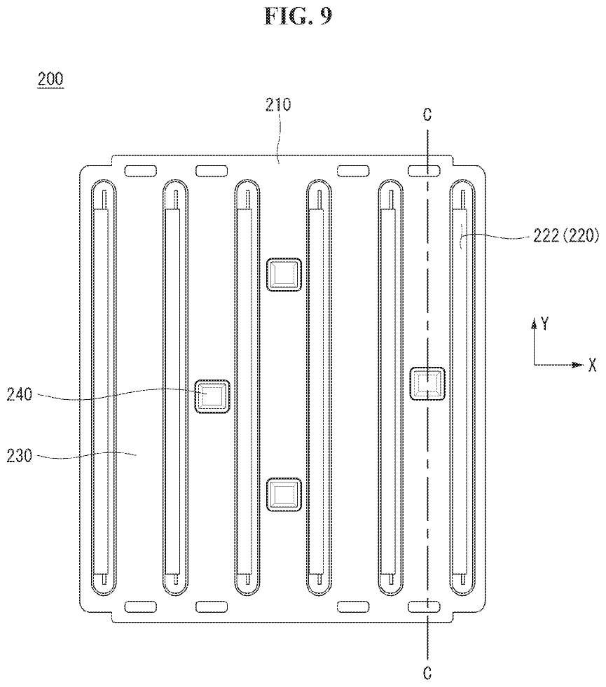

FIG. 9 illustrates a bus bar including a rib according to an embodiment of the present disclosure. In FIG. 9, the first bus bar surface 200a (see FIG. 5), which is the front surface of the bus bar 200, may be observed.

Referring to FIG. 9, the bus bar 200 may include a rib 240. The rib 240 may be formed on the bus bar plate 210. For example, the rib 240 may be formed on the bus bar connection part 230. In other words, the rib 240 may be positioned between the two adjacent bus bar slits 222.

The rib 240 may protrude or be recessed from the bus bar connection part 230. For example, the rib 240 may refer to a front protruding portion or a rear protruding portion of the bus bar connection part 230. That is, the rib 240 may form a shape protruding from one surface of the bus bar connection part 230. The rib 240 may provide rigidity to the bus bar plate 210. For example, the rib 240 can suppress the bus bar plate 210 from being twisted.

A plurality of ribs 240 may be provided. For example, the plurality of ribs 240 may be spaced apart from each other in a direction in which the plurality of bus bar slits 222 are disposed. For example, the plurality of ribs 240 may be spaced apart from each other in a longitudinal direction of the bus bar slit 222.

The longitudinal direction of the bus bar slit 222 may be the “longitudinal direction” of the bus bar 200. For example, the longitudinal direction of the bus bar 200 may be parallel to the Y axis. A direction in which the plurality of bus bar slits 222 are disposed may be a “transverse direction” of the bus bar 200. For example, the transverse direction of the bus bar 200 may be parallel to the X axis. A thickness direction of the bus bar 200 may be the front-rear direction. For example, the thickness direction of the bus bar 200 may be parallel to the Z axis. For example, the thickness direction of the bus bar 200 may be parallel the direction in which the first bus bar surface 200a (see FIG. 5) heads to the second bus bar surface 200b (see FIG. 5).

The rib 240 may be formed by applying a pressure to the bus bar plate 210. For example, the rib 240 may be formed by applying a press process to the bus bar plate 210.

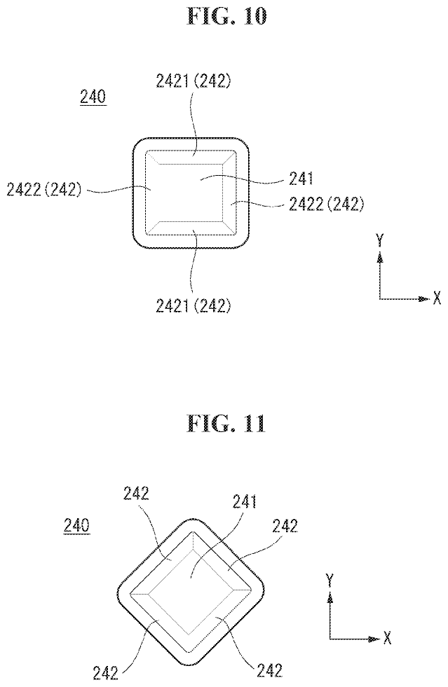

FIGS. 10 to 14 illustrate the rib 240 of various shapes when viewed from the front of the rib 240.

Referring to FIG. 10, the rib 240 may include a rib body 241. The rib body 241 may be spaced apart from the bus bar connection part 230 (see FIG. 3). The rib body 241 may protrude forward or rearward from the bus bar connection part 230 (see FIG. 3).

The rib 240 may include a rib wing 242. The rib wing 242 may connect the rib body 241 and the bus bar connection part 230 (see FIG. 3). The rib wing 242 may be bent and extended from the bus bar connection part 230 (see FIG. 3) and may lead to the rib body 241. The rib wing 242 may be divided based on an extended direction of the rib wing 242.

For example, the rib wing 242 may include a transverse rib wing 2421. The transverse rib wing 2421 may form a shape extending in a transverse direction of the bus bar 200 (see FIG. 3). For example, the transverse rib wing 2421 may extend from one end of the transverse rib wing 2421 in the transverse direction of the bus bar 200 (see FIG. 3) and lead to other end of the transverse rib wing 2421.

A plurality of transverse rib wings 2421 may be provided. For example, the transverse rib wing 2421 may include a pair of transverse rib wings 2421. The pair of transverse rib wings 2421 may face each other. The plurality of transverse rib wings 2421 may be disposed in the longitudinal direction.

For example, the rib wing 242 may include a longitudinal rib wing 2422. The longitudinal rib wing 2422 may form a shape extending in the longitudinal direction of the bus bar 200 (see FIG. 3). For example, the longitudinal rib wing 2422 may extend from one end of the longitudinal rib wing 2422 in the longitudinal direction of the bus bar 200 (see FIG. 3) and lead to other end of the longitudinal rib wing 2422.

A plurality of longitudinal rib wings 2422 may be provided. For example, the longitudinal rib wing 2422 may include a pair of longitudinal rib wings 2422. The pair of longitudinal rib wings 2422 may face each other. The plurality of longitudinal rib wings 2422 may be disposed in the transverse direction.

The rib wing 242 can suppress the bending of the bus bar 200 (see FIG. 3). In other words, the rib wing 242 may provide rigidity to the bus bar plate 210 (see FIG. 3) in a direction opposite to a bending direction of the bus bar 200 (see FIG. 3).

For example, with respect to a direction in which a transverse cross section of the bus bar 200 (see FIG. 3) bends, the transverse rib wing 2421 may provide rigidity to the bus bar plate 210 (see FIG. 3). For example, with respect to a direction in which a longitudinal cross section of the bus bar 200 (see FIG. 3) bends, the longitudinal rib wing 2422 may provide rigidity to the bus bar plate 210 (see FIG. 3).

Referring to FIG. 11, a shape of the rib body 241 may be a rectangle. For example, the shape of the rib body 241 may be a diamond shape or a diamond shape. The plurality of rib wings 242 may be formed. Each of the plurality of rib wings 242 may form a shape extending in a direction in which the transverse direction and the longitudinal direction of the bus bar 200 (see FIG. 3) are combined.

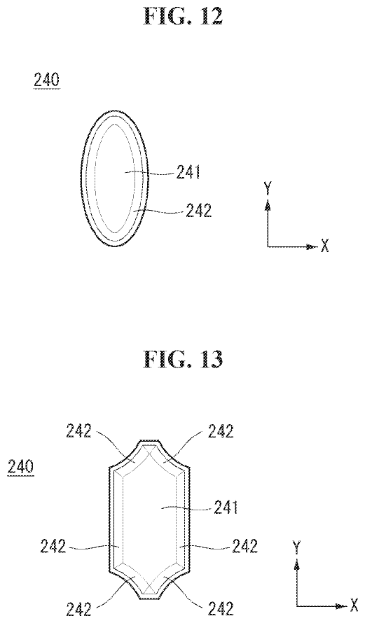

Referring to FIG. 12, a shape of the rib body 241 may be an oval shape elongated in the longitudinal direction of the bus bar 200 (see FIG. 3). The rib wing 242 may be formed along a perimeter of the rib body 241. The rib wing 242 may include elements of the transverse rib wing 2421 (see FIG. 10) and elements of the longitudinal rib wing 2422 (see FIG. 10).

Referring to FIG. 13, a shape of the rib body 241 may be a combined shape of straight lines and curved lines. The rib wing 242 may be formed along the perimeter of the rib body 241. For example, a boundary between the rib wing 242 and the bus bar connection part 230 (see FIG. 3) may be a straight line or/and a curved line.

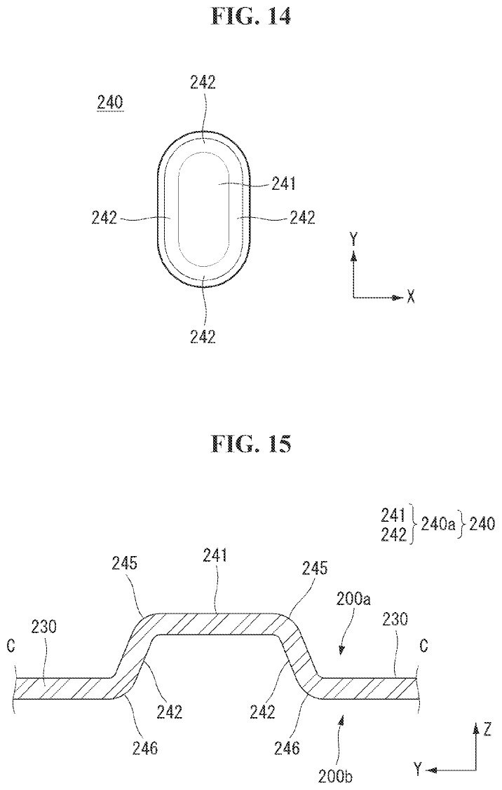

Referring to FIG. 14, a shape of the rib body 241 may be an elongated shape in the longitudinal direction of the bus bar 200 (see FIG. 3). A longitudinal end edge of the rib body 241 may form a curved shape. The rib wing 242 may include the transverse rib wing 2421 and the longitudinal rib wing 2422. The transverse rib wing 2421 may form a convex shape to the outside of the rib body 241.

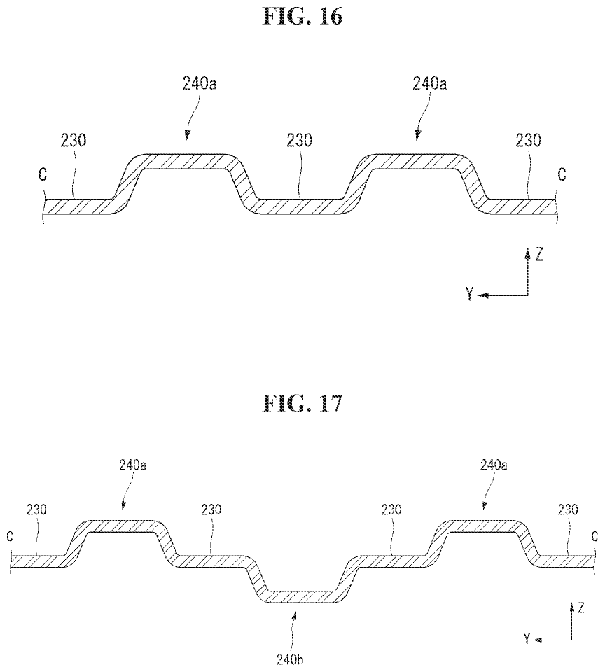

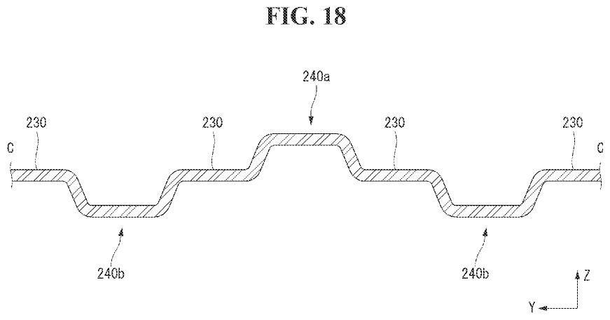

FIG. 15 illustrates a cross section of the bus bar 200 of FIG. 9 taken along C-C. FIG. 16 is a cross-sectional view of the bus bar 200 and illustrates that a plurality of ribs are disposed in a longitudinal direction of a bus bar slit. FIG. 17 is a cross-sectional view of the bus bar 200 and illustrates that one concave rib is formed between two convex ribs. FIG. 18 is a cross-sectional view of the bus bar 200 and illustrates that one convex rib is formed between two concave ribs.

Referring to FIGS. 15 to 18, the rib 240 may form a shape protruding forward or rearward from the bus bar plate 210 (see FIG. 3). A convex rib 240a may form a shape protruding forward from the bus bar plate 210 (see FIG. 3). A concave rib 240b may form a shape protruding rearward from the bus bar plate 210 (see FIG. 3).

Referring to FIG. 15, the rib 240 may include the rib body 241. The rib body 241 may be positioned in front or behind the bus bar connection part 230. The rib 240 may include the rib wing 242. The rib wing 242 may connect the rib body 241 and the bus bar connection part 230. The rib wing 242 may be bent and extended from the rib body 241 and may lead to the bus bar connection part 230.

The rib 240 may include a first bending part 245. The first bending part 245 may be positioned between the rib body 241 and the rib wing 242. The first bending part 245 may refer to a bent portion between the rib body 241 and the rib wing 242. The first bending part 245 may be formed along the perimeter of the rib body 241. The first bending part 245 may be referred to as a “rib inner bending part”.

The rib 240 may include a second bending part 246. The second bending part 246 may be referred to as a “rib boundary bending part”. The second bending part 246 may be positioned between the rib wing 242 and the bus bar connection part 230. The second bending part 246 may refer to a bent portion between the rib wing 242 and the bus bar connection part 230.

The second bending part 246 may be formed along the perimeter of the rib 240. For example, the second bending part 246 may be formed along a boundary between the rib 240 and the bus bar connection part 230. The bending parts 245 and 246 may refer to at least one of the first bending part 245 and the second bending part 246.

For example, the bending parts 245 and 246 may be formed to extend along a direction in which the plurality of bus bar slits 222 (see FIG. 9) are arranged. For another example, the bending parts 245 and 246 may be formed to extend along the longitudinal direction of the bus bar slit 222 (see FIG. 9). For another example, the bending parts 245 and 246 may be formed to extend along a direction in which the arrangement direction of the plurality of bus bar slits 222 (see FIG. 9) and the longitudinal direction of the bus bar slits 222 (see FIG. 9) are combined.

Referring to FIG. 16, a plurality of convex ribs 240a may be disposed in the longitudinal direction of the bus bar 200 (see FIG. 3). For example, two convex ribs 240a may be spaced apart from each other in the longitudinal direction of the bus bar 200 (see FIG. 3). For another example, a plurality of concave ribs 240b (see FIG. 17) may be spaced apart from each other in the longitudinal direction of the bus bar 200 (see FIG. 3).

Referring to FIGS. 17 and 18, the convex rib 240a and the concave rib 240b may be combined and spaced apart from each other in the longitudinal direction of the bus bar 200 (see FIG. 3). For example, referring to FIG. 17, one concave rib 240b may be disposed between two convex ribs 240a. For example, referring to FIG. 18, one convex rib 240a may be disposed between two concave ribs 240b.

Referring to FIGS. 16 to 18, since the plurality of ribs 240 are spaced apart from each other in the longitudinal direction of the bus bar 200 (see FIG. 3), the plurality of ribs 240 can effectively suppress bending of the bus bar 200 (see FIG. 3).

For example, the convex rib 240a can effectively suppress the bending of the bus bar 200 (see FIG. 3) in a direction in which the central portion of the bus bar 200 (see FIG. 3) protrudes rearward.

For example, the concave rib 240b can effectively suppress the bending of the bus bar 200 (see FIG. 3) in a direction in which the central portion of the bus bar 200 (see FIG. 3) protrudes forward.

Referring to FIGS. 1 to 18, the bus bar slit 222 may not be formed in the bus bar coupling part 220. In this case, the electrode lead 112 may be coupled to the bus bar coupling part 220. For example, the electrode lead 112 may be coupled to the bus bar coupling part 220 through welding.

The bus bar slit 222 may have an elongated shape in the longitudinal direction. The electrode lead 112 may be inserted into and coupled to the bus bar slit 222. The electrode lead 112 may be inserted into the bus bar slit 222 and protrude from the bus bar 200 toward the front of the bus bar 200.

The electrode lead 112 may be welded at the bus bar slit 222. For example, the electrode lead 112 may be coupled to the bus bar 200 along the bus bar slit 222 by a wobble type welding.

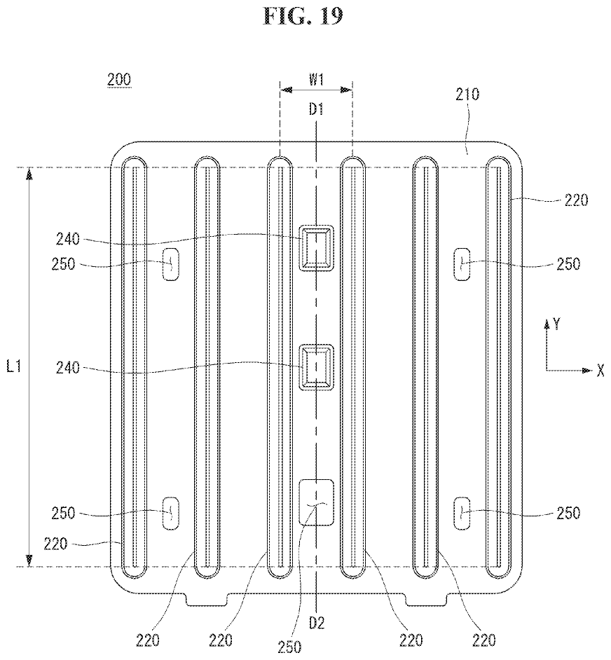

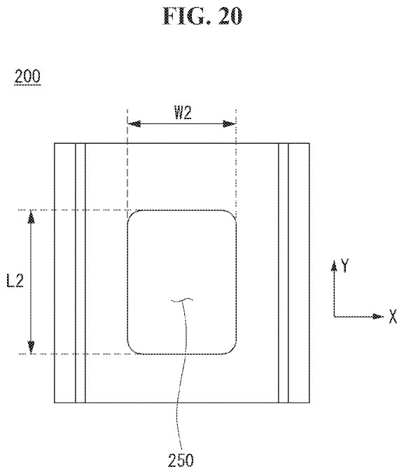

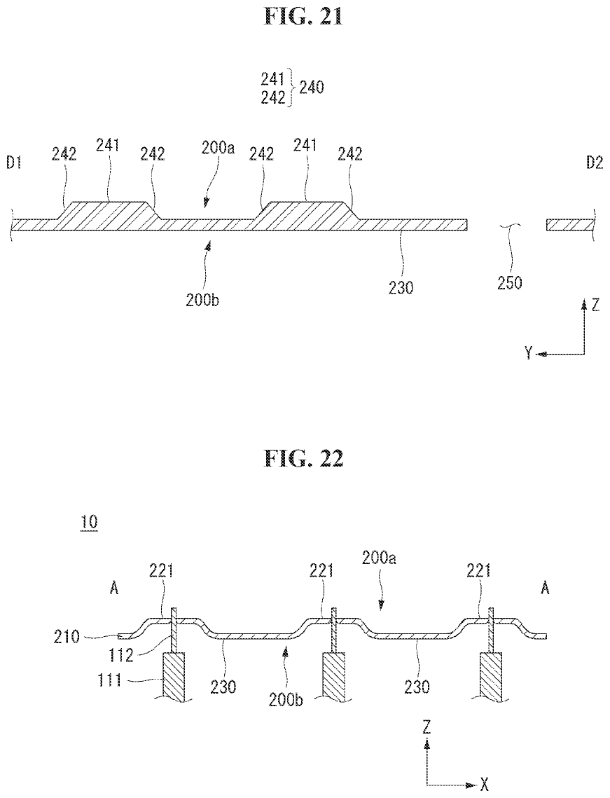

FIG. 19 illustrates a bus bar having a reinforcement hole 250 formed in a bus bar connection part in accordance with an embodiment of the present disclosure. In FIG. 19, the front surface of the bus bar may be observed. FIG. 20 is a partial enlarged view of a bus bar illustrated in FIG. 19. FIG. 21 illustrates a cross section of a bus bar of FIG. 19 taken along D1-D2.

Referring to FIGS. 19 to 21, the bus bar 200 may include a reinforcement hole 250. The reinforcement hole 250 may be a hole formed in the bus bar plate 210. For example, the reinforcement hole 250 may be a hole formed in the bus bar connection part 230. The reinforcement hole 250 may pass through the bus bar connection part 230 in the thickness direction of the bus bar connection part 230.

The reinforcement hole 250 may perform a function similar to the rib 240. For example, the reinforcement hole 250 may suppress or prevent the bus bar plate 210 from being twisted.

A plurality of reinforcement holes 250 may be provided. For example, the plurality of reinforcement holes 250 may be spaced apart from each other in a direction in which the plurality of bus bar coupling parts 220 are disposed. For example, the plurality of reinforcement holes 250 may be spaced apart from each other in the longitudinal direction of the bus bar coupling part 220.

For example, a first length L1 may be a longitudinal length of the bus bar coupling part 220. For example, a first width W1 may be a distance between two adjacent bus bar coupling parts 220. That is, the first width W1 may be a transverse length of the bus bar connection part 230.

Alternatively, the first width W1 may be a distance between adjacent bus bar slits 222. That is, the first width W1 may be a distance between coupling points of two adjacent bus bar coupling parts 220. The coupling point of the bus bar coupling part 220 may be a point where the bus bar coupling part 220 and the electrode lead 112 (see FIG. 6) meet. For example, a second length L2 may be a longitudinal length of the reinforcement hole 250. For example, a second width W2 may be a transverse length of the reinforcement hole 250.

A size of the reinforcement hole 250 may correspond to the longitudinal length and a transverse interval of the bus bar coupling part 220 and a thickness of the bus bar plate 210. For example, the second length L2 may be greater than or equal to the thickness of the bus bar plate 210 and less than or equal to 0.5 times the first length L1. For example, the second width W2 may be greater than or equal to ⅓ times the first width W1 and may be less than or equal to the first width W1.

The reinforcement hole 250 and the rib 240 may be combined. A “reinforcement member” may include at least one of the reinforcement hole 250 and the rib 240. That is, the reinforcement members 240 and 250 may mean a combination of the reinforcement hole 250 and the rib 240. A plurality of reinforcement members 240 and 250 may be provided. The plurality of reinforcement members 240 and 250 may be spaced apart in the longitudinal direction or spaced apart in the transverse direction.

The rib 240 may protrude from one surface of the bus bar connection part 230. The rib 240 may be formed on one surface of the bus bar connection part 230. For example, the rib 240 may be coupled to one surface of the bus bar connection part 230. That is, the rib 240 may not be formed by press-processing the bus bar plate 210, and may be formed or coupled to the bus bar connection part 230 by another method. Alternatively, the rib 240 may be integrally formed with the bus bar connection part 230.

The rib 240 may include the rib wing 242. The rib wing 242 may form a boundary with the bus bar connection part 230. The rib wing 242 may be inclined with respect to the bus bar connection part 230. The rib wing 242 may extend from the bus bar connection part 230.

The rib 240 may include the rib body 241. The rib body 241 may extend from the rib wing 242. The rib wing 242 may surround the rib body 241. A thickness of the rib body 241 may be greater than a thickness of the bus bar connection part 230. A thickness of the rib wing 242 may increase as it goes from the bus bar connection part 230 to the rib body 241.

The rib 240 may be formed on not only the first bus bar surface 200a but also the second bus bar surface 200b. Alternatively, the plurality of ribs 240 may be a combination of the rib formed on the first bus bar surface 200a and the rib formed on the second bus bar surface 200b.

FIG. 22 is a cross-sectional view of a battery module of FIG. 2 taken along A-A and illustrates that an electrode lead passes through a bus bar and protrudes from the bus bar.

Referring to FIG. 22, the electrode lead 112 may pass through the bus bar slit 222 (see FIG. 5) and protrude from the bus bar plate 210. The bus bar plate 210 and the electrode lead 112 may be coupled by welding at a boundary between the bus bar plate 210 and the electrode lead 112.

Some embodiments or other embodiments of the present disclosure described above are not mutually exclusive or distinct from each other. Configurations or functions of some embodiments or other embodiments of the present disclosure described above can be used together or combined with each other.

It is apparent to those skilled in the art that the present disclosure can be embodied in other specific forms without departing from the spirit and essential features of the present disclosure. Accordingly, the above detailed description should not be construed as limiting in all aspects and should be considered as illustrative. The scope of the present disclosure should be determined by rational interpretation of the appended claims, and all modifications within an equivalent scope of the present disclosure are included in the scope of the present disclosure.

What is claimed is:

1. A bus bar comprising:
a bus bar plate having a front surface and a rear surface;
a plurality of bus bar coupling parts formed on the bus bar plate, each of the plurality of bus bar coupling parts extending in a longitudinal direction, the plurality of bus bar coupling parts being spaced apart in a transverse direction;
a bus bar connection part formed on the bus bar plate and positioned between the plurality of bus bar coupling parts; and
an at least one rib positioned on the bus bar connection part, the at least one rib protruding from at least one of the front surface and the rear surface of the bus bar plate.

2. The bus bar of claim 1, wherein each of the at least one rib includes at least one of:
a convex rib protruding from the front surface of the bus bar plate; and
a concave rib protruding from the rear surface of the bus bar plate.

3. The bus bar of claim 2, wherein the convex rib is concave on the rear surface, and
wherein the concave rib is concave on the front surface.

4. The bus bar of claim 1, further comprising:
a reinforcement hole formed in the bus bar connection part, the reinforcement hole passing through the bus bar plate in a thickness direction of the bus bar plate.

5. The bus bar of claim 4, wherein a longitudinal length of the reinforcement hole is greater than or equal to a thickness of the bus bar plate and is less than or equal to 0.5 times a longitudinal length of the bus bar coupling part, and
wherein a transverse length of the reinforcement hole is greater than or equal to a value obtained by dividing a transverse length of the bus bar connection part by 3 and is less than or equal to the transverse length of the bus bar connection part.

6. The bus bar of claim 1, wherein each of the at least one rib includes a rib wing bent and extended from the bus bar connection part.

7. The bus bar of claim 6, wherein each of the at least one rib wing includes a transverse rib wing extending in the transverse direction.

8. The bus bar of claim 6, wherein each of the at least one rib further includes a rib body that is bent and extended from the rib wing and is spaced apart from the bus bar connection part.

9. The bus bar of claim 1, wherein each of the at least one rib includes a rib wing extending from the bus bar connection part, and
wherein the rib wing is inclined with respect to the bus bar connection part.

10. The bus bar of claim 9, wherein each of the at least one rib further includes a rib body extending from the rib wing, and
wherein the rib wing surrounds the rib body.

11. A battery module comprising:
a plurality of battery cells each including a battery cell body and an electrode lead protruding forward from the battery cell body, the plurality of battery cells being disposed in a transverse direction; and
a bus bar coupled to the electrode leads at a front of the battery cell body,
wherein the bus bar includes:
a bus bar plate having a front surface facing the front and a rear surface facing the battery cell body;
a plurality of bus bar coupling parts respectively coupled to the electrode leads of the plurality of battery cells and disposed in the transverse direction;
a bus bar connection part formed on the bus bar plate and positioned between the plurality of bus bar coupling parts; and
an at least one rib positioned on the bus bar connection part, the at least one rib protruding from at least one of the front surface and the rear surface of the bus bar plate.

12. The battery module of claim 11, wherein each of the at least one rib includes at least one of:
a convex rib protruding from the front surface of the bus bar plate; and
a concave rib protruding from the rear surface of the bus bar plate.

13. The battery module of claim 11, wherein each of the at least one rib includes a rib wing bent from the bus bar connection part.

14. The battery module of claim 13, wherein each of the at least one rib wing includes a transverse rib wing extending in the transverse direction.

15. The battery module of claim 11, wherein the electrode lead is coupled to the bus bar by a welding.

16. The battery module of claim 15, wherein the electrode lead passes through a bus bar slit formed in the bus bar coupling part and protrudes from the bus bar slit, and
wherein the electrode lead is coupled to the bus bar along the bus bar slit by a wobble type welding.

17. The battery module of claim 11, wherein the bus bar further includes a reinforcement hole formed in the bus bar connection part, and
wherein the reinforcement hole passes through the bus bar plate in a thickness direction of the bus bar plate.

18. The battery module of claim 17, wherein a longitudinal length of the reinforcement hole is greater than or equal to a thickness of the bus bar plate and is less than or equal to 0.5 times a longitudinal length of the bus bar coupling part, and
wherein a transverse length of the reinforcement hole is greater than or equal to a value obtained by dividing a transverse length of the bus bar connection part by 3 and is less than or equal to the transverse length of the bus bar connection part.

19. The battery module of claim 11, wherein each of the at least one rib includes a rib wing extending from the bus bar connection part, and
wherein the rib wing is inclined with respect to the bus bar connection part.

20. The battery module of claim 19, wherein each of the at least one rib further includes a rib body extending from the rib wing, and
wherein the rib wing surrounds the rib body.
